(19) United States
(12) Patent Application Publication
(10) Pub. No.: US 2008/0091846 A1
(43) Pub. Date: Apr. 17, 2008

(54) CREATION AND TRANSACTION PROCESSES OF INTELLIGENT DOCUMENTS

(76) Inventor: CHI HUNG DANG, Tucson, AZ (US)

Correspondence Address: CHI HUNG DANG, 7901 EAST HARDY STREET, TUCSON, AZ, 85750, US

(21) Appl. No.: 11/549,685

(22) Filed: Oct. 16, 2006

(51) Int. Cl. G06F 15/16

(52) U.S. Cl. 709/246

(57) ABSTRACT

Document transaction processes between systems comprising the following steps: The client requests a form; the host supplies the form rendered into HTML and PDF from XML template; the client fills in the form and submits the completed form to the host; the host receives and processes the form, extracts key information and stores the processed form; the host composes and sends a responding form for confirmation and the processed information to the client; the client receives and processes and stores the responding form; the client makes change or mark/correct any discrepancy/dispute on the responding form and returns it back to the host; the host receives and processes the returned responding form containing change and discrepancy/dispute marked by the client; the host revises the responding form and returns it to the client; the client receives, processes, and stores the responding form.

### BACKGROUND OF THE INVENTION

1. Field of the Invention

The present invention relates to a document management system that renders intelligent form templates designed in the format best suited for the host system into forms in different formats best suited for the client system; and to the document transaction cycles between systems.

2. Background of the Invention

With the availability of computers and workstations, there is a desire to convert documents into electronic form for efficient editing, storage and management. Since the arrival of the Internet and E-commerce, such desire has become more apparent. The tasks of converting, processing and managing documents are very complex processes because documents always will be presented and exchanged in both forms: hard copy and electronic forms. To further complicate this matter, electronic documents that are structured such as XML and non-structured such as text messages, spreadsheet and Microsoft Word files may be generated from different platforms with different formats and presentation soft wares. For hard copy file, the commonly used process is scanning hard-copy documents and storing the images as TIFF files before converting to PDF format which provides additional system flexibility. In U.S. Pat. No. 7,007,231, Dang disclosed A document management system for creating and storing interactive documents, which comprises parsing engines that parse documents contained in data streams fed into said parsing engines from document acquisition engines, parsing engines contain mapping programs to map each page of an input document into one or a plurality of predetermined presentation zones following the presentation template, parsing programs to parse the presentation of each presentation zone into one or a plurality of output presentation formats determined by the presentation template, and reconstructing programs to reconstruct the completed presentation of said page in one or a plurality of presentation options by retrieving and placing selected output presentation formats called for by the specific presentation option or options into each presentation zone following the presentation template; the output presentation format options comprise: figure in image presentation format; text in text format describing the text content, in this format, the recognition of text symbols is required, and the text can be regenerated with different fonts and sizes; mathematic equation presentation in executable equation format; spreadsheet presentation in executable calculation spreadsheet format; blank presentation format showing blank; and file inserting format for inserting pre-generated file. But Dang did not disclose how the presentation template might be constructed.

In 2003, Adobe released a product named LiveCycle for creating and managing interactive forms. The developers use Adobe Designer to build the intelligent forms and document templates in XML format, which can be rendered as HTML or PDF forms by the Adobe Form Server. The intelligent XML forms and document templates are checked in Adobe Form Manager that is a centralized repository for managing all your business forms (those created in Adobe Designer and those created with other tools). The intelligent XML forms and document templates that can be transformed into HTML or PDF forms comprising all of six Output Presentation Formats proposed in Dang's patent by Adobe Form Server. The parsed document forms & document are returned and stored at Adobe Form Manager, which provides a Web-based interface that allows users and administrators to select particular forms for completion. When a user selects a form for completion, Form Manager delivers it pre-populated with information drawn from the user's profile (such as name, employee ID number, etc.). The Web Servers deliver the parsed forms in HTML and Adobe File formats to the user's Browser over HTTP to be reconstructed by the Browser and Adobe Reader into completed Presentation. Users can save Adobe PDF forms to a local machine and reopen them offline, retaining all of their intelligence and interactive features. In this system, the template creation process involves great amount of well-trained human designer's effort. These are a few application examples of Adobe LiveCycle products:

Financial services. Banks are using Web portals to transform branch banking, including teller and lending processes. Adobe products can be used to create a single, unified system to manage banking processes, business content, and documents. When documents are connected to processes, banks can prepopulate forms with information data and provide self-calculating forms with data validation. This helps streamline document- and forms-intensive processes such as account opening and loan origination.

Insurance. Adobe products offer insurance providers the concept to automate labor-intensive processes while maintaining the paper-based paradigm that agents and policyholders understand. Interactive policy renewal documents can be generated and distributed to policyholders who, using Adobe Reader software or any Web browser, can then review, modify and approve, and submit back to the carrier for processing. In addition, by integrating claims forms with core systems, insurance companies can quickly and cost-effectively move business processes online.

Health services. Employee benefits administration and health coverage enrollments can utilize Web-based applications, which allow updates and coverage choices to occur online through the use of a portal means that patients and employees can access their accounts after-hours and on weekends, enjoy faster response times, and avoid paper bottlenecks. Providers can also make selection decisions easier by including reference material and calculation tools alongside forms.

Government. Some examples of document-intensive government services include motor vehicle registration and payment, social services delivery, business registration, and inter-government communication. Using Adobe forms linked to these business processes, a government agency can create a form, process it, and then post the form for access by constituents. The constituent retrieves and completes the form, archives it, signs it, and returns it to the agency.

Typically with Adobe's technology, the process comprises of these steps:
The client goes online and requests for a form, the Adobe Form Server detects the client's browser environment and converts the intelligent form template containing all intelligent logic designed in XML format to the formats that are best suited for the client browser such as HTML and PDF.
The client fills in all required information with assistance of the form intelligent logics.
The client submits the form after completion.
The host receives and processes the form by routing it to all authorized personnel for reviewing, editing, and approval. The form imbedded intelligence assists the form routing and processing
The form is stored in database.

What is missing in the Adobe process are the additional steps such as confirmation notification, responding forms and others necessary for completing the communication and processing cycle; furthermore, it focuses more in converting the form to the formats that are best suited for the client browser environment, not for the client system data computing, content processing and management. One of the most important shortcomings of Adobe process is its viewing of the client only as an individual user, not an enterprise comprising multi users within its own computing network; to overcome this shortcoming, the form templates must contain: the logic for routing the forms to people within the host system, who are in the list of routing addresses defined by the host system, and to people within the client system, who are in the list of routing addresses defined by the client system; and the logic for pre-population of the form with data from different sources in the host system and the logic for pre-population of the form with data from different sources in the client system.

Several existing HTML server based processes such as Banking Online Payment, Purchasing order do offer the confirmation notification, and responding forms; however, the HTML format is lacking intelligent and interactive properties.

This invention proposes a complete form exchanging and processing cycles that utilize the Adobe's intelligent form template based concept and Dang's interactive form presentation together with additional improvements, which would address the above short comings.

The improvements of this invention over the Adobe LiveCycle are the addition of processing steps such as initial cycle responding step and follow-up cycle responding step; and the addition of the form intelligent logics such as the routing to destinations within the client system, and the data mapping between the forms and data sources within the client system.

The improvements of this invention over HTML server based processes is the addition of intelligent and interactive properties, and ability to render the form in different formats for different platforms from a form template designed in XML, which is considered as the enterprise standard format due to its mobility across the enterprise system components.

### SUMMARY OF THE INVENTION AND OBJECTS

A document management system that renders intelligent form templates designed in the format best suited for the host system such as XML into forms in different formats best suited for the client system such as HTML, XML and PDF, and provides the document transaction cycles between systems.

For creating interactive documents presentation, the system comprises parsing engines that parse documents contained in data streams fed into said parsing engines from document acquisition engines, parsing engines contain mapping programs to map each page of an input document into one or a plurality of predetermined presentation zones following the presentation template, parsing programs to parse and format the presentation of each presentation zone into one or a plurality of output presentation formats determined by the presentation template, and reconstructing programs to reconstruct the completed presentation of said page in one or a plurality of presentation options by retrieving and placing selected output presentation formats called for by the specific presentation option or options into each presentation zone following the presentation template.

The document transaction cycles between systems comprise the steps of:
initial document producing step: wherein the host system creates the basic cycle initial form in format or formats best suited for the client system;
initial document transmitting step: wherein the basic cycle initial form is sent to the client system;
initial document client processing step: wherein the client system receives, processes the basic cycle initial form and sends the completed basic cycle initial form back to the host system;
initial document host processing step: wherein the host system receives, processes the completed basic cycle initial form;
responding document producing step: wherein host system creates the basic cycle responding form in format or formats best suited for the client system; responding document transmitting step: wherein the basic cycle responding form is sent to the client system;
responding document client processing step: wherein the client system receives, processes the basic cycle responding form and sends the completed basic cycle responding form back to the host system;
responding document host processing step: wherein the host system receives, processes the completed basic cycle responding form;
follow-up responding document producing step: wherein the host system creates the follow-up cycle responding form in format or formats best suited for the client system;
follow-up responding document transmitting step: wherein the follow-up cycle responding form is sent to the client system;
follow-up responding document client processing step: wherein the client system receives, processes the follow-up cycle responding form.

The object of this invention is to provide a document management system that acquires documents from different sources, converts said documents into intelligent electronic forms suitable for complete image presentation, data processing and content modification. Another object is to provide effective and efficient document processing and transaction processes between host system and client systems.

These and other objects and advantages of this invention will become apparent through examining the following description of the arrangement, operations and functionalities of the constituent components and appended claims in conjunction with the attached drawings.

### BRIEF DESCRIPTION OF THE DRAWINGS

FIG. 1 is a schematic partial illustration of a document management system of the present invention.

FIG. 2 is a schematic partial illustration of a document management service provider host system of the present invention.

### DETAILED DESCRIPTION OF THE INVENTION

In real life, a complete document transaction process must consist of:
Step1: The client requests a form.
Step2: The host supplies the form to the client.
Step3: The client fills in the form, probably with some assistance from the host.
Step4: The client submits the completed form to the host.
Step5: The host receives the form.
Step6: The host checks the form for mistakes and missing information. If there is any, the host contacts the client for correct information to complete the form.
Step7: The host processes the form, extracts key information and stores the processed form.
Step8: The host composes and sends a responding form for confirmation and the processed information to the client.
Step9: The client receives and processes and stores the responding form.
Step10: The client makes changes or marks/corrects any discrepancy/dispute on the responding form and returns it back to the host.
Step11: The host receives and processes the returned responding form containing changes and discrepancies/disputes marked by the client.
Step12: The host revises the responding form and returns it to the client.
Step13: The client receives, processes, and stores the responding form.
Repeat the step10 to step 13 until both parties mutually accept the responding form.

If the form contains the intelligence that can assist the client to correctly fill in the form, then step6 can be omitted. In case of the host and the client both are enterprises, each comprises multi users within its own computing network, and are connected through Internet, the form templates must contain: the logic for routing the forms to people within the host system, who are in the list of routing addresses defined by the host system, and to people within the client system, who are in the list of routing addresses defined by the client system; and the logic for pre-population of the form with data from different sources in the host system and the logic for pre-population of the form with data from different sources in the client system. The data may come from data base or from other forms.

Consider the purchasing order process as an example case:
Step1: The client requests the purchase order form.
Step2: The host supplies the purchase order form to the client.
Step3: The client fills in the form with required information such as: name, address, phone number, credit card number, purchase items, quantities, and others, probably with some assistance from the host. If the client is an enterprise, the form must be routed to other persons for inputs and approvals.
Step4: The client submits the completed form to the host.
Step5: The host receives the form.
Step6: The host checks the form for mistakes and missing information. If there is any, the host contacts the client for correct information to complete the form.
Step7: The host processes the form, fills in additional information such as item prices, extracts key information and stores the processed form. If the host is an enterprise, the form must be routed to other persons for inputs and approvals.
Step8: The host composes and sends an invoice form for confirmation and the processed information such as item price, taxes, shipping cost, total due amount, shipping date to the client.
Step9: The client receives and processes and stores the invoice form.
Step10: The client makes changes or marks/corrects any discrepancy/dispute on the invoice form and returns a copy of said invoice form back to the host.
Step11: The host receives and processes the returned copy of said invoice form containing changes and discrepancies/disputes marked by the client.
Step12: The host revises the invoice form and returns it to the client.
Step13: The client receives, processes, and stores the updated invoice form.
Repeat the step10 to step 13 until both parties mutually accept the responding form.

As proposed by this invention: In a computing environment having a connection to a network, a document management system that comprises at least one host system serving the documents and at least one client system receiving the documents provides the document exchanging process, comprising a basic cycle and one or more follow-up cycles; each system may contain only one computer or a network of computers. When two systems are exchanging documents, each can be host system and client system, depending on who is serving and who is receiving the document at certain moment.

THE BASIC CYCLE comprises the steps of:

INITIAL DOCUMENT REQUESTING STEP: (Step1: The client requests a form) the client request for the form from his browser devices such desktop components such as personal computers and workstations, and wireless mobile devices such as mobile phones and smartphones or sphones, which are any electronic handheld devices that integrate the functionality of a mobile phones, personal digital assistant (PDA) or other information appliances.
The browser platforms comprises
   Standard Web browsers.
   Browsers supported in wireless devices, such as personal digital assistants and mobile phones.
The browser formats and languages comprises
   Web: MS HTML, MS DHTML, HTML 3.2, CSS2 HTML, existing HTML, and accessible HTML.
   Wireless: CHTML, WML, and PocketHTML
   Desktop components: PDF, PDF Forms, and Adobe Form Client”

INITIAL DOCUMENT PRODUCING STEP: (Step2: The host supplies the form to the client) the host system detects the client's browser platform and format to parse and format the basic cycle initial form template designed in XML into the intelligent basic cycle initial form in formats best suited for the client's browser. The form template is designed in XML since it is considered as the enterprise standard format due to its mobility across the enterprise system components. The common browser format is HTML while XML still play a minor and supporting role. The host system also provides a means for requesting the forms in PDF and XML formats. With HTML and PDF, users can complete forms by entering data into HTML wizard panels, or use the familiar paper-like interface of PDF forms, which can be saved at local device for later filing or archiving. With XML, users can integrate the form data into his system for efficient and automated data processing and management without converting the form format.

The XML form template based concept provides the most flexibility since the form template can easily migrate between the enterprise components and be rendered into different browser formats and platforms. Furthermore, XML provides the embedding of important enterprise data and intelligent business logics into the form template, which allows:
The pre-population (pre-filled information such as customer names or account numbers) of the form with data from different sources in the host system.
The ability to allow the client to define the pre-population of the form with data from different sources in the client system. The form template contains logic to map specific form presentation zones to specific data addresses located within the client system (composed and stored inside the client system, data is from data base or from other forms). However, for security measure, the form template only contains the mapping logic, the specific data addresses defined by the client system are inserted into the mapping logic after the form template passes through the client firewall.
The automatic calculations (such as mortgage interest rates).
The ability to define business logic within the form (An example of this kind of business logic might be, “If this person doesn't review this form within two days, route it to the next person on the review list.”).
The ability to be integrated with enterprise systems through Web services so that data-entry events trigger an associated workflow.
The ability to allow the form to be routed to a list of people within the host system, retaining the embedded rights so that the next recipient has the same functionality enabled.
The ability to allow the client to define a list of people in the client system, to whom the form to be routed to. The form template contains the logic to rout the form to specific destination addresses located within the client system (composed and stored inside the client system). However, for security measure, the form template only contains the routing logic, the specific destination addresses defined by the client system are inserted into the routing logic after the form template passes through the client firewall.
The ability for the document to serve as a vehicle for returning the information to the enterprise applications, as information is added or updated, helping the enterprise avoid costly and error-prone manual data entry.
The ability to map different data formats from different applications to one unified form. For example, if a transaction involves three different systems for credit checks, order fulfillment, and order shipping, it is impractical to make users fill out three separate forms just to accommodate the system architecture. The Intelligent Document Platform makes it possible to integrate information from different form fields into different XML documents for back-end systems.
The ability to encrypt the confidential and classified information such as social security number, credit card number, financial information; such encrypted data only can be decrypted by the host system. The form template contains encrypting logic that automatically encrypts the confidential information as the client system sends the form to the host system.

To build a interactive form presentation, the system contains mapping programs to map the form template into one or a plurality of predetermined presentation zones following the presentation template, parsing programs to parse and format the presentation of each presentation zone into one or a plurality of output presentation formats determined by the presentation template, and reconstructing programs such as Web browsers to reconstruct the complete presentation of said form in one or a plurality presentation options by retrieving and placing selected output presentation formats called for by the specific presentation option or options into each presentation zone following the presentation template; the output presentation format options comprise: figure in image presentation format such as JPEG, GIF, TIFF, and PDF; text in text format describing the text content, in this format, the recognition of text symbols is required, and the text can be regenerated with different fonts and sizes; calculation expression presentation in executable calculation format such as mathematic equation presentation in executable equation format and spreadsheet presentation in executable calculation spreadsheet format; blank presentation format showing blank; and file inserting format for inserting pre-generated file. The presentation template may be embedded in the form template or stored in any components of the system such as servers, repositories, and databases.

INITIAL DOCUMENT TRANSMITTING STEP: (Step2: The host supplies the form to the client) wherein the basic cycle initial form is sent to the client system; with the form format in Web page format such as HTML, the form is sent by the Web server; with the form format in PDF, the form is sent by Email as file attachment. If the client does define a list of people in the client system, to whom the form must be routed to, the form is then forwarded to those people.

INITIAL DOCUMENT CLIENT PROCESSING STEP: (Step3: The client fills in the form, probably with some assistance from the host) wherein the client system receives, processes the basic cycle initial form by filling in the required information data, and saves the completed basic cycle initial form before sending it back to the host system (Step4: The client submits the completed form to the host); these processes may be performed by the client system personnel, or by the client program software with or without the human interventions and assistances. If the client does define the logic and mapping for the pre-population of the form with data from different sources in the client system, the form is automatically filled with said data.

INITIAL DOCUMENT HOST PROCESSING STEP: (Step5: The host receives the form) wherein the host system receives; saves into data base; routes to a list of people within the host system; processes the completed basic cycle initial form by: filling in the required information data, (Step6: The host checks the form for mistakes and missing information. If there is any, the host contacts the client for correct information to complete the form) performing error checking & correction, performing data checking & calculation (Step7: The host processes the form, extracts key information and stores the processed form); and saves the processed completed basic cycle initial form; these processes may be performed by the host system personnel, or by the host program software with or without the human interventions and assistances. The relevant processed information is extracted and saved in database.

RESPONDING DOCUMENT PRODUCING STEP: (Step8: The host composes and sends a responding form for confirmation and the processed information to the client) Similar to the initial document producing step, the host system detects the client's browser platform and format to parse and format the basic cycle responding form template designed in XML into the intelligent basic cycle responding form in formats best suited for the client's browser. The form template is designed in XML. The host system also provides a means for requesting the forms in PDF and XML formats.

The basic cycle responding form template is also embedded with important enterprise data and intelligent business logics into the form template, which allows:
The pre-population (pre-filled information such as customer names or account numbers) of the form with data from different sources in the host system.
The ability to allow the client to define the pre-population of the form with data from different sources in the client system. The form template contains logic to map specific form presentation zones to specific data addresses located within the client system (composed and stored inside the client system, data is from data base or from other forms). However, for security measure, the form template only contains the mapping logic, the specific data addresses defined by the client system are inserted into the mapping logic after the form template passes through the client firewall.
The automatic calculations (such as mortgage interest rates).
The ability to define business logic within the form (An example of this kind of business logic might be, “If this person doesn't review this form within two days, route it to the next person on the review list.”).
The ability to be integrated with enterprise systems through Web services so that data-entry events trigger an associated workflow.
The ability to allow the form to be routed to a list of people within the host system, retaining the embedded rights so that the next recipient has the same functionality enabled.
The ability to allow the client to define a list of people in the client system, to whom the form to be routed to. The form template contains the logic to rout the form to specific destination addresses located within the client system (composed and stored inside the client system). However, for security measure, the form template only contains the routing logic, the specific destination addresses defined by the client system are inserted into the routing logic after the form template passes through the client firewall.
The ability for the document to serve as a vehicle for returning the information to the enterprise applications, as information is added or updated, helping the enterprise avoid costly and error-prone manual data entry.
The ability to map different data formats from different applications to one unified form. For example, if a transaction involves three different systems for credit checks, order fulfillment, and order shipping, it is impractical to make users fill out three separate forms just to accommodate the system architecture. The Intelligent Document Platform makes it possible to integrate information from different form fields into different XML documents for back-end systems.
The ability to encrypt the confidential and classified information such as social security number, credit card number, financial information; such encrypted data only can be decrypted by the host system. The form template contains encrypting logic that automatically encrypts the confidential information as the client system sends the form to the host system.

To build a interactive form presentation, the system contains mapping programs to map the form template into one or a plurality of predetermined presentation zones following the presentation template, parsing programs to parse and format the presentation of each presentation zone into one or a plurality of output presentation formats determined by the presentation template, and reconstructing programs such as Web browsers to reconstruct the complete presentation of said form in one or a plurality presentation options by retrieving and placing selected output presentation formats called for by the specific presentation option or options into each presentation zone following the presentation template; the output presentation format options comprise: figure in image presentation format such as JPEG, GIF, TIFF, and PDF; text in text format describing the text content, in this format, the recognition of text symbols is required, and the text can be regenerated with different fonts and sizes; calculation expression presentation in executable calculation format such as mathematic equation presentation in executable equation format and spreadsheet presentation in executable calculation spreadsheet format; blank presentation format showing blank; and file inserting format for inserting pre-generated file. The presentation template may be embedded in the form template or stored in any components of the system such as servers, repositories, and databases.

During this process, the relevant processed information extracted in the initial document host processing step is inserted into the basic cycle responding form. RESPONDING DOCUMENT TRANSMITTING STEP: (Step8: The host composes and sends a responding form for confirmation and the processed information to the client) Similar to the initial document transmitting step, when the basic cycle responding form is transmitted to the client system with the form format in Web page format such as HTML, the form is sent by the Web server; with the form format in PDF, the form is sent by Email as file attachment. If the client does define a list of people in the client system, to whom the form must be routed to, the form is then forwarded to those people.

THE FOLLOW-UP CYCLE comprises the steps of:

RESPONDING DOCUMENT CLIENT PROCESSING STEP: (Step9: The client receives and processes and stores the responding form) wherein the client system receives, processes the basic cycle responding form by filling in the required information data, and saves the completed basic cycle responding form before sending it back to the host system (Step10: The client makes changes or marks/corrects any discrepancy/dispute on the responding form and returns it back to the host). These processes may be performed by the client system personnel, or by the client program software with or without the human interventions and assistances. If the client does define the logic and mapping for the pre-population of the form with data from different sources in the client system, the form is automatically filled with said data.

RESPONDING DOCUMENT HOST PROCESSING STEP: wherein the host system receives, processes the completed basic cycle responding form and extracts the relevant processed information;

(Step11: The host receives and processes the returned responding form containing changes and discrepancies/disputes marked by the client) wherein the host system receives; saves into data base; routes to a list of people within the host system; processes the completed basic cycle responding form by: filling in the required information data, performing error checking & correction, performing data checking & calculation (Step12: The host revises the responding form and returns it to the client); and saves the processed completed basic cycle responding form; these processes may be performed by the host system personnel, or by the host program software with or without the human interventions and assistances. The relevant processed information is extracted and saved in database.

FOLLOW-UP RESPONDING DOCUMENT PRODUCING STEP: Similar to the initial document producing step, the host system detects the client's browser platform and format to parse and format the follow-up cycle responding form template designed in XML into the intelligent follow-up cycle responding form in formats best suited for the client's browser. The form template is designed in XML. The host system also provides a means for requesting the forms in PDF and XML formats.

The follow-up cycle responding form template is also embedded with important enterprise data and intelligent business logics into the form template, which allows:
The pre-population (pre-filled information such as customer names or account numbers) of the form with data from different sources in the host system.
The ability to allow the client to define the pre-population of the form with data from different sources in the client system. The form template contains logic to map specific form presentation zones to specific data addresses located within the client system (composed and stored inside the client system, data is from data base or from other forms). However, for security measure, the form template only contains the mapping logic, the specific data addresses defined by the client system are inserted into the mapping logic after the form template passes through the client firewall.
The automatic calculations (such as mortgage interest rates).
The ability to define business logic within the form (An example of this kind of business logic might be, “If this person doesn't review this form within two days, route it to the next person on the review list.”).
The ability to be integrated with enterprise systems through Web services so that data-entry events trigger an associated workflow.
The ability to allow the form to be routed to a list of people within the host system, retaining the embedded rights so that the next recipient has the same functionality enabled.
The ability to allow the client to define a list of people in the client system, to whom the form to be routed to. The form template contains the logic to rout the form to specific destination addresses located within the client system (composed and stored inside the client system). However, for security measure, the form template only contains the routing logic, the specific destination addresses defined by the client system are inserted into the routing logic after the form template passes through the client firewall.
The ability for the document to serve as a vehicle for returning the information to the enterprise applications, as information is added or updated, helping the enterprise avoid costly and error-prone manual data entry.
The ability to map different data formats from different applications to one unified form. For example, if a transaction involves three different systems for credit checks, order fulfillment, and order shipping, it is impractical to make users fill out three separate forms just to accommodate the system architecture. The Intelligent Document Platform makes it possible to integrate information from different form fields into different XML documents for back-end systems.
The ability to encrypt the confidential and classified information such as social security number, credit card number, financial information; such encrypted data only can be decrypted by the host system. The form template contains encrypting logic that automatically encrypts the confidential information as the client system sends the form to the host system.

To build a interactive form presentation, the system contains mapping programs to map the form template into one or a plurality of predetermined presentation zones following the presentation template, parsing programs to parse and format the presentation of each presentation zone into one or a plurality of output presentation formats determined by the presentation template, and reconstructing programs such as Web browsers to reconstruct the complete presentation of said form in one or a plurality presentation options by retrieving and placing selected output presentation formats called for by the specific presentation option or options into each presentation zone following the presentation template; the output presentation format options comprise: figure in image presentation format such as JPEG, GIF, TIFF, and PDF; text in text format describing the text content, in this format, the recognition of text symbols is required, and the text can be regenerated with different fonts and sizes; calculation expression presentation in executable calculation format such as mathematic equation presentation in executable equation format and spreadsheet presentation in executable calculation spreadsheet format; blank presentation format showing blank; and file inserting format for inserting pre-generated file. The presentation template may be embedded in the form template or stored in any components of the system such as servers, repositories, and databases.

During this process, the relevant processed information extracted in the responding document host processing step is inserted into the follow-up cycle responding form.

FOLLOW-UP RESPONDING DOCUMENT TRANSMITTING STEP: Similar to the initial document transmitting step, when the follow-up cycle responding form is transmitted to the client system with the form format in Web page format such as HTML, the form is sent by the Web server; with the form format in PDF, the form is sent by Email as file attachment. If the client does define a list of people in the client system, to whom the form must be routed to, the form is then forwarded to those people.

FOLLOW-UP RESPONDING DOCUMENT CLIENT PROCESSING STEP: wherein the client system receives, processes the follow-up cycle responding form

The follow-up responding document producing step, follow-up responding document transmitting step, follow-up responding document client processing step are parts of a follow-up cycle for resolving any change or dispute occurred after the basic cycle, one or more follow-up cycles continue to take place until all modifications & disputes are resolved.

To perform all the above steps, the document management system comprises: Means for the host system to create the basic cycle initial form in format or formats best suited for the client system from the basic cycle initial form template designed in the, which comprises: parsing program and formatting program to convert XML to HTML or PDF.

Means for the host system to send the basic cycle initial form to the client system, which comprises: Web Server and form server.

Means for the client system to receive, process the basic cycle initial form and send the completed basic cycle initial form back to the host system, which comprises: HTML browser and Adobe PDF reader.

Means for the host system to receive the completed basic cycle initial form that is processed and sent by the client system, which comprises: Web Server and form server.

Means for the host system to process the completed basic cycle initial form and to extracts the relevant processed information, which comprises: form server, form processor, and form manager.

Means for the host system to create the basic cycle responding form in format or formats best suited for the client system from the basic cycle responding form template designed in the form template format or formats, and to insert relevant processed information into the basic cycle responding form, which comprises: parsing program and formatting program to convert XML to HTML or PDF. Means for the host system to send basic cycle responding form to the client system, which comprises: Web Server and form server.

Means for the client system to receive, process the basic cycle responding form and send the completed basic cycle responding form back to the host system, which comprises: HTML browser and Adobe PDF reader.

Means for the host system to receive the completed basic cycle responding form that is processed and sent by the client system, which comprises: Web Server and form server.

Means for the host system to process the completed basic cycle responding form and to extracts the relevant processed information, which comprises: form server, form processor, and form manager.

Means for the host system to create the follow-up cycle responding form in format or formats best suited for the client system from the follow-up cycle responding form template designed in the form template format or formats, and to insert relevant processed information into the follow-up cycle responding form, which comprises: parsing program and formatting program to convert XML to HTML or PDF.

Means for the host system to send follow-up cycle responding form to the client system, which comprises: Web Server and form server.

Means for the client system to receive, process the follow-up cycle responding form, which comprises: HTML browser and Adobe PDF reader.

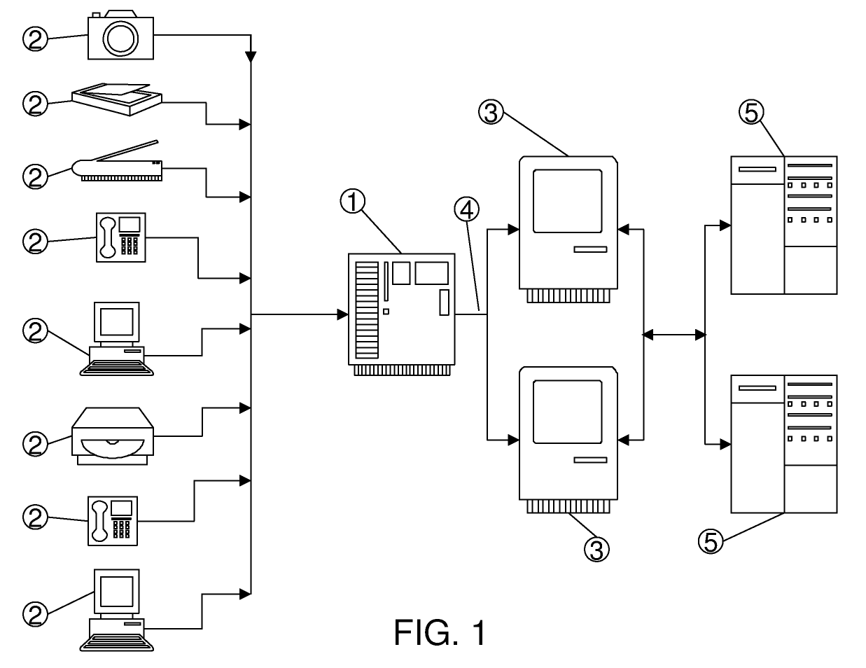

Referred to FIG. 1, one preferred embodiment for creating document templates, comprising:

Document acquisition engines 1 that may include one or a plurality of computers connected to collections of document generators 2 such as Fax machines, page scanners, digital cameras, telephones, and workstations. With Fax machines and page scanners, the images are scanned and stored as TIFF files by the scan application. TIFF files provide compact storage of image data using CCITT Group IV compression. The images from digital cameras are typically collected as JPEG or TIFF files. It is presently known that the documents generated by telephones could be in voice format, text format and image format. With the workstations, documents can be generated with several software packages such as Solid works, Auto CAD, Pro E and Microsoft word, these documents may be sent to the acquisition engines 1 in the original formats if the acquisition engines support such formats, otherwise they must be converted to TIFF or JPEG. The document acquisition engines 1 convert all document data to one single format before sending it to next step in the process. The most readily available format is the print stream, since most software packages include their own device drivers for printing.

Parsing engines 3 comprising one or a plurality of computers, each may contain mapping programs to map each page of an input document into one or a plurality of predetermined presentation zones following the presentation template, parsing programs to parse and format the presentation of each presentation zone into one or a plurality of output presentation formats determined by the presentation template, and reconstructing programs to reconstruct the completed presentation of said page in one or a plurality of presentation options by retrieving and placing selected output presentation formats called for by the selected option or options into each presentation zone following the presentation template. Each presentation template must be designed specifically for each document type and may include one or a plurality of complete presentation options that have identical presentation zone mapping but different zone presentation formats. Each presentation template comprises complete presentation option identifications, presentation zone identifications, mapped location of each presentation zone, and parsing program identification of each zone for each complete presentation option. Parsing programs may be stored within the parsing engines 3 with unique identifications for retrieval reference. Most parsing programs are commercially available and are selected based on the input and output platforms and formats.

Repository engines 5 that comprise one or a plurality of computers, each contains data storage hardware such as disk drives, optical drives and tape drives and repository management to manage the data files storage, indexing, searching, and retrieval processes. The repository management may include self-contained file management such as JAR or ZIP and combinations of database such as LDAP, WEBDAV Server, and SOAP Server together with file management such as NIS, NFS, and NTFS.

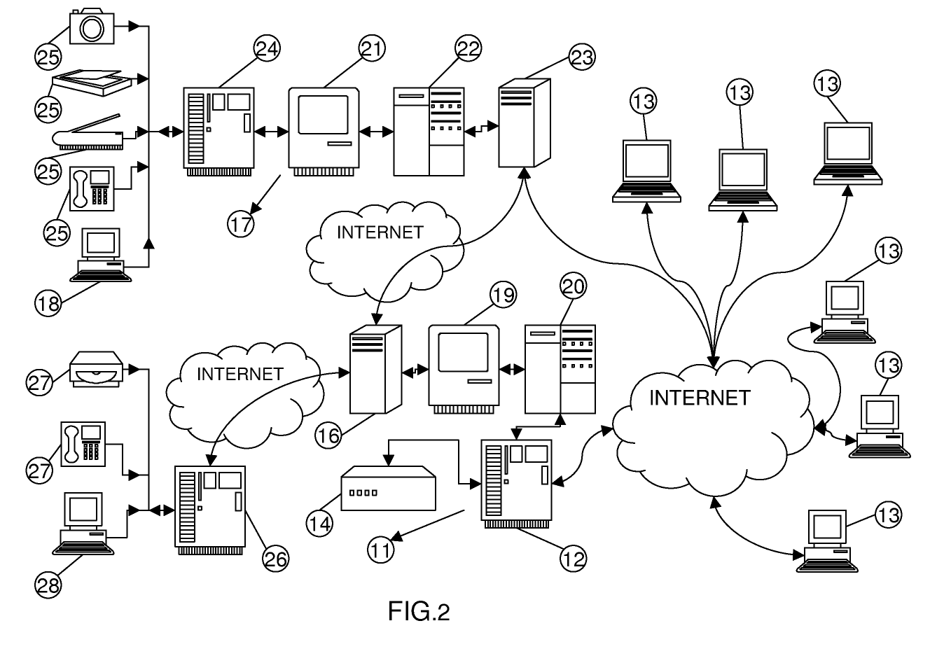

With the expansion of E-commerce across the Internet, many businesses not only need to provide static information promoting their images, products and services, they must also interact with customers or clients. Interaction by exchanging documents such as purchase orders, service request applications, billing statements, shipment status, and transaction statements, requires complex document management and expensive development effort. Therefore, it is desirable to contract out this type of file management to a service provider, especially for small organizations that have limited resources and capital. In general, a document service provider system as illustrated in FIG. 2 comprises:

A host document management system 11 that is locally located at the facility of said service provider. The said host document management system comprises one or a plurality of Web server engines 12 that facilitate the communication services such as receiving and responding to the user requests between the host document management system 11 and a collection of Internet user systems 13, security engines 14 such as LDAP servers for authenticating users and authorizing services, host parsing engines 19 for parsing documents, host repository engines 20 for storing output data and host communication engines 16 for controlling the communication between the host and the client systems. The Web server engines 12 may include one or a plurality of Web page templates for each organization and Web page re-composition programs, which compose the Web pages by filling in the templates with related data retrieved from the host repository engines 20. The Web page templates are preferably generated in HTML conforming to XML format and the Web page re-composition program is preferably written in JAVA class. The re-composition program may be designed to further include means for modifying the Web page templates dynamically by the system administrators.

One or a plurality of client document management systems 17 that is remotely located at the facilities of the service subscribers and is linked to the host system 11 across the Internet. Each of the said client document management systems 17 comprises client parsing engines 21 for parsing documents, client repository engines 22 for storing output data from the parsing engines 21, client communication engines 23 for controlling the communication between the host system 11 and the said client system and document acquisition engines 24 to collect document presentation data from a collection of client document generators 25 and computers 18; the document acquisition engines 24 convert data into one single format, envelop all data into data streams and send said data streams to the client parsing engines 21. The parsed data is sent across the Internet to the host document management system 11 where the documents are reconstructed by the host parsing engines 19. Data is stored at either the client repository engines 22 or the host repository engines 20 or both. This type of set up is more suitable for subscribers who have large workload requirements. To improve efficiency by reducing data storage space and cutting down the time required for parsing, reconstructing, and data transmitting, the static figures and text in image presentation format of documents of the same types are generated in advance and stored in the host parsing engines 19 that service the said types of document. The stored static data is later used for the document reconstruction process. Since only the dynamic data is sent across the Internet, it automatically provides additional security measure due to the fact that the intruders have no templates and static data to reconstruct the complete documents.

One or a plurality of client document acquisition engines 26 that are remotely located at the facilities of the service subscribers. The document acquisition engines 26 collect document presentation data from a collection of client document generators 27 and computers 28, convert data into one single format, envelop all data into data streams and send said data streams across the Internet to the host system 11 where the documents are parsed, and reconstructed by the host parsing engines 19. Data is stored at the host repository engines 20. This type of set up is more suitable for subscribers who have small workload requirements.

Communication across the Internet is an effective way to reduce the communication infrastructure cost, however, it puts the data security at risk. Virtual Private Network (VPN) may be implemented to provide secure connections across the Internet between the host system and the client systems. The VPN encapsulates the IP data gram in order to maintain data privacy and integrity. To improve the level of security protection, the communication engines may further include firewalls and other security measures.

As parts of two ways communication, the authorized users may request for documents and fill in required information or make modifications before sending said documents back directly to the service subscribers who are responsible for processing and responding to the said documents. It is possible that the modified documents are sent to and stored at the service provider system 11 for later retrieval by the service subscribers. The service subscribers may elect to post the status and results of their responses through the document management service provider where the users may gain access, view, and keep track of the responses.

Having described and disclosed my invention, I claim:

1: In a computing environment having a connection to a network, a document management process, comprising a basic cycle, which comprises the steps of:
initial document producing step: wherein the document producing process of the host system parses and formats the basic cycle initial form template designed in the form template format or formats into the basic cycle initial form in format or formats best suited for the client system;
initial document transmitting step: wherein the basic cycle initial form is sent to the client system;
initial document client processing step: wherein the client system receives, processes the basic cycle initial form and sends the completed basic cycle initial form back to the host system;
initial document host processing step: wherein the host system receives, processes the completed basic cycle initial form and extracts the relevant processed information;
responding document producing step: wherein the document producing process of the host system parses and formats the basic cycle responding form template designed in the form template format or formats into the basic cycle responding form in format or formats best suited for the client system; and the relevant processed information is inserted into the basic cycle responding form;
responding document transmitting step: wherein the basic cycle responding form is sent to the client system.

2: The document management process of claim 1 wherein the form template formats comprises XML and the formats best suited for the client system comprise at least one of these formats: HTML, XML, and PDF.

3: The document management process of claim 1 wherein the basic cycle initial form template, and the basic cycle responding form template comprise the logic for routing the forms to people within the host system, who are in the list of routing addresses defined by the host system, and to people within the client system, who are in the list of routing addresses defined by the client system.

4: The document management process of claim 1 wherein the basic cycle initial form template, and the basic cycle responding form template comprise the logic for pre-population of the form with data from different sources in the host system and the logic for pre-population of the form with data from different sources in the client system.

5: The document management process of claim 1 wherein the basic cycle initial form template, and the basic cycle responding form template comprise the encrypting logic that automatically encrypts the confidential information when said forms exit the host system and the client system.

6: The document management process of claim 1 further comprises at least one follow-up cycle, comprising:
responding document client processing step: wherein the client system receives, processes the basic cycle responding form and sends the completed basic cycle responding form back to the host system;
responding document host processing step: wherein the host system receives, processes the completed basic cycle responding form and extracts the relevant processed information;
follow-up responding document producing step: wherein the document producing process of the host system parses and formats the follow-up cycle responding form template designed in the form template format or formats into the follow-up cycle responding form in format or formats best suited for the client system; and
the relevant processed information is inserted into the follow-up cycle responding form;
follow-up responding document transmitting step: wherein the follow-up cycle responding form is sent to the client system.
follow-up responding document client processing step: wherein the client system receives, processes the follow-up cycle responding form.

7: The document management process of claim 6 wherein the form template formats comprises XML and the formats best suited for the client system comprise at least one of these formats: HTML, XML, and PDF.

8: The document management process of claim 6 wherein the basic cycle initial form template, the basic cycle responding form template, and the follow-up cycle responding form template comprise the logic for routing the forms to people within the host system, who are in the list of routing addresses defined by the host system, and to people within the client system, who are in the list of routing addresses defined by the client system.

9: The document management process of claim 6 wherein the basic cycle initial form template, the basic cycle responding form template, and the follow-up cycle responding form template comprise the logic for pre-population of the form with data from different sources in the host system and the logic for pre-population of the form with data from different sources in the client system.

10: The document management process of claim 6 wherein the basic cycle initial form template, the basic cycle responding form template, and the follow-up cycle responding form template comprise the encrypting logic that automatically encrypts the confidential information when said forms exit the host system and the client system.

11: The document management process of claim 1 wherein the document producing process of the host system further subdivides the basic cycle initial form template presentation into one a plurality of presentation zones, parses and formats each presentation zone into one or a plurality of output presentation formats.

12: The document management process of claim 11 wherein the output presentation format options comprise: figure in image presentation format; text in text format describing the text content, calculation expression presentation in executable calculation format.

13: The document management process of claim 1 wherein the document producing process of the host system further subdivides the basic cycle responding form template presentation into one a plurality of presentation zones, parses and formats each presentation zone into one or a plurality of output presentation formats.

14: The document management process of claim 13 wherein the output presentation format options comprise: figure in image presentation format; text in text format describing the text content, calculation expression presentation in executable calculation format.

15: The document management process of claim 1, which is provided by a document management system, comprising:
means for the host system to parses and formats the basic cycle initial form template designed in the form template format or formats into the basic cycle initial form in format or formats best suited for the client system;
means for the host system to send the basic cycle initial form to the client system;
means for the client system to receive, process the basic cycle initial form and send the completed basic cycle initial form back to the host system;
means for the host system to receive the completed basic cycle initial form that is processed and sent by the client system.
means for the host system to process the completed basic cycle initial form and to extract the relevant processed information;
means for the host system to parse and format the basic cycle responding form template designed in the form template format or formats into the basic cycle responding form in format or formats best suited for the client system; and to insert relevant processed information into the basic cycle responding form;
means for the host system to send basic cycle responding form to the client system.

16: The document management process of claim 15 further comprises:
means for the client system to receive, process the basic cycle responding form and send the completed basic cycle responding form back to the host system;
means for the host system to receive the completed basic cycle responding form that is processed and sent by the client system;
means for the host system to process the completed basic cycle responding form and to extract the relevant processed information;
means for the host system to parse and format the follow-up cycle responding form template designed in the form template format or formats into the follow-up cycle responding form in format or formats best suited for the client system; and
to insert relevant processed information into the follow-up cycle responding form;
means for the host system to send follow-up cycle responding form to the client system;
means for the client system to receive, process the follow-up cycle responding form.

17: In a computing environment having a connection to a network, a document management system comprising at least one host system and at least one client system, wherein the document producing process of the host system parses and formats the form template designed in the form template format or formats into the form in format or formats best suited for the client system; the form template comprises the logic to rout the form to specific destination addresses located within the client system.

18: The document management system of claim 17, wherein the specific destination addresses are defined by the client system and are inserted into the routing logic after the form template enters the client system.

19: The document management system of claim 17, wherein the form template further comprises the logic to rout the form to specific destination addresses located within the host system.

20: In a computing environment having a connection to a network, a document management system comprising at least one host system and at least one client system, wherein the document producing process of the host system parses and formats the form template designed in the form template format or formats into the form in format or formats best suited for the client system; the form template comprises logic to map specific form presentation zones to specific data addresses located within the client system.

21: The document management system of claim 20, wherein the specific data addresses are defined by the client system and are inserted into the mapping logic after the form template enters the client system.

22: The document management system of claim 20, wherein the form template further comprises logic to map specific form presentation zones to specific data addresses located within the host system.

23: The document management system of claim 20, wherein the form template further comprises the logic that automatically encrypts the confidential information as the client system sends the form to the host system.
